(19) United States
(12) Patent Application Publication
(10) Pub. No.: US 2015/0255195 A1
(43) Pub. Date: Sep. 10, 2015

(54) VOLTAGE NONLINEAR RESISTIVE ELEMENT

(71) Applicant: NGK Insulators, Ltd., Nagoya-City (JP)

(72) Inventor: Naokuni MURAMATSU, Nagoya-City (JP)

(21) Appl. No.: 14/721,025

(22) Filed: May 26, 2015

Related U.S. Application Data
(63) Continuation of application No. PCT/JP2013/078786, filed on Oct. 24, 2013.

(30) Foreign Application Priority Data
Nov. 29, 2012 (JP) 2012-260608

(51) Int. Cl. H01C 7/10; B22F 3/105; H01C 17/00

(52) U.S. Cl. CPC H01C 7/10; H01C 17/00; B22F 3/105

(57) ABSTRACT

A voltage nonlinear resistive element 20 of the present invention includes a voltage nonlinear resistive material 30 composed of a copper alloy which has a two-phase structure containing a Cu phase 31 and a Cu—Zr compound phase 32 not containing a eutectic phase, and electrodes 21 and 22. The voltage nonlinear resistive material 30 may have a mosaic-shaped structure in which the Cu phase 31 and the Cu—Zr compound phase 32 are dispersed as crystals with a size of 10 μm or less in a cross-sectional view. The Cu—Zr compound phase 32 may be at least one of Cu₅Zr, Cu₉Zr₂, and Cu₈Zr₃. Also, the voltage nonlinear resistive material 30 may be formed by spark plasma sintering of a Cu—Zr binary alloy powder. The voltage nonlinear resistive material 30 may contain 0.2 at % or more and 18.0 at % or less of Zr.

### BACKGROUND OF THE INVENTION

1. Field of the Invention

The present invention relates to a voltage nonlinear resistive element.

2. Description of the Related Art

Zener diode-capacitor parallel circuits, varistors, and the like have been known as countermeasure components for protecting circuits and elements of electronic apparatuses from overvoltages such as abnormal voltage (surge), static electricity (ESD), and the like. Among these, the varistors are frequently used because they can be miniaturized as compared with the Zener diode-capacitor parallel circuits. Typical examples of the varistors include a ZnO varistor. The ZnO varistor generally has a crystal structure formed by a process of firing a ceramic powder. Also, it is considered that a high-resistance crystal grain boundary region and a low-resistance crystal grain region are present, a Schottky barrier is formed in the interface between both regions, and a mechanism mainly including a tunneling effect due to overvoltage works to cause a rapid increase in current (exhibit voltage nonlinear resistance characteristics).

However, miniaturization and higher integration of electronic apparatuses have recently been advanced, and accordingly demands for miniaturization and lower voltage of varistors have been increased. For these demands, for example, it has been proposed to control a crystal grain diameter by adjusting added elements and a firing process and to alternately stacking a thin fired ceramic layer and an electrode layer (refer to Patent Literatures 1 to 3).

### CITATION LIST

### Patent Literature

PTL 1: JP 05-055010 A

PTL 2: JP 05-234716 A

PTL 3: JP 05-226116 A

### SUMMARY OF INVENTION

However, the varistor voltages of ZnO varistors are generally several tens V, and lower varistor voltages are desired because the varistor voltages described in Patent Literatures 1 to 3 are 3 V or more. Also, miniaturization is also unsatisfactory.

The present invention has been achieved for solving the problem and a main object of the present invention is to provide a novel voltage nonlinear resistive element.

As a result of earnest research for achieving the object described above, the inventors found that in examination of current-voltage characteristics of a copper alloy formed by powdering a copper alloy containing Zr and spark-plasma-sintering the resultant powder, voltage nonlinear resistance characteristics are exhibited, and a rapid increase in current occurs at a relatively low voltage of about 1 to 3 V, leading to the achievement of the present invention.

That is, a voltage nonlinear resistive element of the present invention includes

a voltage nonlinear resistive material composed of a copper alloy having a two-phase structure which contains Cu and a Cu—Zr compound not containing a eutectic phase; and

an electrode.

According to the voltage nonlinear resistive element, a novel voltage nonlinear resistive element including a Zr-containing alloy as a voltage nonlinear resistive material can be provided. That is, the copper alloy of the present invention can be used as the voltage nonlinear resistive material. Although the reason for achieving this effect is unclear, it is supposed as follows. For example, the voltage nonlinear resistive material of the present invention has a region composed of copper and a region containing at least zirconium. In addition, the former plays the same function as a low-resistance crystal grain region of a ZnO varistor, and the latter plays the same function as a high-resistance crystal grain boundary region of a ZnO varistor. It is supposed that when a voltage is increased due to an electric barrier like a Schottky barrier formed at the interface between both regions, a mechanism such as a tunneling effect works due to overvoltage, thereby causing a rapid increase in current.

### BRIEF DESCRIPTION OF DRAWINGS

FIG. 1 is a Cu—Zr binary phase diagram.

FIG. 2 is a schematic view showing an example of a voltage nonlinear resistive element 20 of the present invention.

FIG. 3 is cross-sectional SEM-BEI images of a Cu-5 at % Zr alloy powder.

FIG. 4 is the results of X-ray diffraction measurement of a Cu-5 at % Zr alloy powder.

FIG. 5 is SEM-BEI images of copper alloys formed by SPS of Cu—Zr alloy powders.

FIG. 6 is FE-SEM images of a Cu-5 at % Zr alloy (a SPS material of Experiment Example 3).

FIG. 7 is the results of X-ray diffraction measurement of a Cu-5 at % Zr alloy (a SPS material of Experiment Example 3).

FIG. 8 is results of measurement of tensile strength and conductivity of SPS materials of Cu—Zr alloys.

FIG. 9 is cross-sectional SEM images of a voltage nonlinear resistive material of Example 1.

FIG. 10 is a SEM composition image and the results of AFM-current measurement of a voltage nonlinear resistive material.

FIG. 11 is the analysis results of AFM-current measurement in a viewing field 1.

FIG. 12 is a SEM composition image and the results of AFM-current measurement of a voltage nonlinear resistive material.

FIG. 13 is the analysis results of AFM-current measurement in a viewing field 2.

### DESCRIPTION OF THE PREFERRED EMBODIMENTS

A voltage nonlinear resistive element of the present invention includes a voltage nonlinear resistive material composed of a copper alloy having a two-phase structure which contains Cu and a Cu—Zr compound not containing a eutectic phase, and an electrode. The term “voltage nonlinear resistive material” represents a material exhibiting current-voltage nonlinear resistance characteristics that conductivity is exhibited when a voltage exceeds a specified value, and examples thereof include a material exhibiting current-voltage characteristics of a diode or the like, and a material exhibiting current-voltage characteristics of a varistor or the like.

In the voltage nonlinear resistive element, of the present invention, the voltage nonlinear resistive material is a copper alloy having a two-phase structure which contains Cu and a Cu—Zr compound not containing a eutectic phase. A Cu phase is a phase containing Cu, and may be, for example, a phase containing α-Cu. Also, the Cu phase may contain solute Zr in a degree which allows dissolution in an equilibrium diagram. The Cu phase may not contain a eutectic phase. The term “eutectic phase” represents, for example, a phase containing Cu and a Cu—Zr compound described below. The Cu phase may be composed of crystals with a size of 10 μm or less in a cross-sectional view of the voltage nonlinear resistive material. The size of the Cu phase represents the long side of the structure of the Cu phase in a SEM image of a cross-section of the voltage nonlinear resistive material.

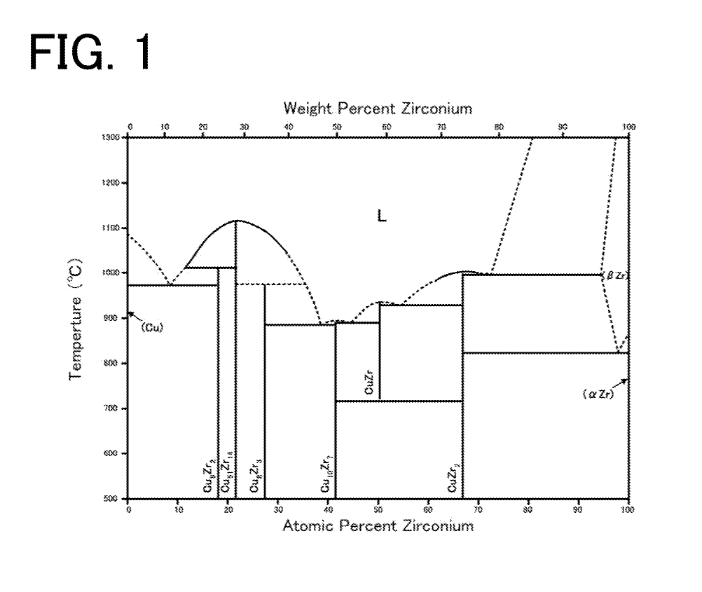

The voltage nonlinear resistive material of the present invention contains a Cu—Zr compound phase. FIG. 1 is a Cu—Zr binary phase diagram with Zr content as abscissa and temperature as ordinate (source: D. Arias and J. P. Abriata Bull Alloy phase diagram 11 (1990), 452-459). Examples of the Cu—Zr compound phase include various phases shown in the Cu—Zr binary phase, diagram of FIG. 1. Although not shown in the Cu—Zr binary phase diagram, a Cup Zr phase which is a compound with a composition very close to Cu₉Zr₂ these is also included. The Cu—Zr compound phase may contain, for example, at least one of a Cu₅Zr phase, a Cu₉Zr₂ phase, and a Cu₈Zr₃ phase. Among these, the Cu₅Zr phase and the Cu₉Zr₂ phase are preferred. The Cu₅Zr phase and the Cu phase are expected to exhibit the voltage nonlinear resistance characteristics. The phases can be identified by, for example, structural observation using a scattering transmission electron microscope (STEM) and then composition analysis using an energy dispersive X-ray spectrometer (EDX) and structural analysis using nano-beam electron diffraction (ED) for a viewing field subjected to the structural observation. The Cu—Zr compound phase may be a single phase or a phase containing two or more Cu—Zr compounds. For example, the Cu—Zr compound phase may be a Cu₉Zr₂ single phase, a Cu₅Zr single phase, a Cu₈Zr₃ single phase, phase including a Cu₅Zr phase as a main phase and another Cu—Zr compound (Cu₃Zr₂ or Cu₈Zr₃) as a slab-phase, or a phase including a Cu₉Zr₂ phase as a main phase and another Cu—Zr compound (Cu₅Zr or Cu₈Zr₃) as a secondary phase. The main phase represents a phase present at the highest ratio (volume ratio) among the Cu—Zr compound phases, and the secondary phase represents a phase other than the main phase among the Cu—Zr compound phases. The Cu—Zr compound phase does not include a eutectic phase. As described above, the eutectic phase represents a phase containing Cu and a Cu—Zr compound. Also, the Cu—Zr compound phase may be composed of crystals of a size of 10 μm or less in a cross-sectional view of the voltage nonlinear resistive material. The size of the Cu—Zr compound phase represents the long side of the structure of the Cu—Zr compound phase in a SEM image of a cross-section of the voltage nonlinear resistive material.

The voltage nonlinear resistive material of the present invention contains Cu and Zr. The amount of Zr is not particularly limited but is preferably 18 at % or less. This is because as seen from the binary phase diagram of FIG. 1, a Cu—Zr compound phase is obtained. The Zr amount is preferably 0.2 at or more and 18.0 at % or less. Among these, the Zr amount is preferably 0.2 at % or more and 8.0 at % or less and more preferably 5.0 at % or more and 8.0 at % or less. This is because with the Zr amount of 0.2 at % or more, the voltage nonlinear resistance characteristics can be obtained, and with the Zr amount of 8.0 at % or less, the structure can be made fine by processing because of good processability. On the other hand, the Zr amount may be 8.0 at or more and 18.0 at % or less. In this case, the voltage nonlinear resistive material contains the Cu—Zr compound phase as the main phase and is thus considered to be suitable for use for a voltage nonlinear resistive element with high withstand voltage. In addition, the voltage nonlinear resistive material may contain elements other than Cu and Zr. Examples of the other elements include those added intentionally, impurities inevitably mixed in a manufacturing process, and other elements such as oxygen and carbon which are observed as oxide and carbide, respectively.

The voltage nonlinear resistive material of the present invention may have a mosaic-shaped structure in which crystals with a size of 10 μm or less are dispersed in a cross-sectional view. In this case, the Cu phase and the Cu—Zr compound phase can be observed in a mosaic-shaped structure in a SEM backscattered electron image obtained by observing a cross-section of the voltage nonlinear resistive material. The mosaic-shaped structure can be confirmed with, for example, the Zr amount of 5.0 at % or more. The mosaic-shaped structure may be a uniform dense two-phase structure. The Cu phase and the Cu—Zr compound phase do not contain a eutectic phase. Further, the phases do not contain dendrites and a structure formed by growth of the dendrites.

The voltage nonlinear resistive material of the present invention may be formed by spark plasma sintering (SPS) of a Cu—Zr binary alloy powder. Also, the voltage nonlinear resistive material may be formed by spark plasma sintering of a Cu—Zr binary alloy power with a hypo-eutectic composition. SPS can easily form a copper alloy having a two-phase structure including Cu and a Cu—Zr compound not containing a eutectic phase. The hypo-eutectic composition may be, for example, composition containing 0.2 at % or more and 8.00 at or less of Zr and the balance Cu. The voltage nonlinear resistive, material may contain an inevitable component (for example, a trace amount of oxygen). The spark plasma sintering is described in detail below but may be performed by applying a direct-current pulsed current so that the temperature is 0.9 Tm° C. or less (Tm(° C.) is he melting point of the alloy powder). This can easily form a mosaic-shaped structure including the Cu phase and the Cu—Zr compound phase. Also, the voltage nonlinear resistive material may be composed of a Cu—Zr binary alloy powder formed by a high-pressure gas atomization method using a Cu—Zr binary alloy. This facilitates powder metallurgy.

The voltage nonlinear resistive, material of the present invention may have a mosaic-shaped structure formed by spark plasma sintering of a Cu—Zr binary alloy powder, wire drawing, and then stretching in the drawing direction. The voltage nonlinear resistive material of the present invention may have a mosaic-shaped structure formed by spark plasma sintering of a Cu—Zr binary alloy powder, rolling, and then flattening in the rolling direction. In this case also, the material has the voltage-nonlinear resistance characteristics. Also, the voltage-nonlinear resistance characteristics can be adjusted by changing the shape of the structure through processing.

The voltage nonlinear resistive material of the present invention may exhibit the voltage-nonlinear resistance characteristics including a voltage (so-called varistor voltage) at which conductivity is shown at a voltage within a range of 0.2 V to 3.0 V. This desirably facilitates the utilization for an electronic device used at a relatively low voltage. The varistor voltage may be for example, 0.4 V, 0.6 V, or 1.0 V. In addition, a voltage range showing insulation properties can be adjusted by stacking elements.

The electrode in the voltage nonlinear resistive element of the present invention is not particularly limited but, for example, various electrodes such as Cu, Cu alloy, Ag, Au, and Pt electrodes, and the like can be used. The method for forming the electrode is not particularly limited, but various methods such as welding, soldering, printing, and the like can be used.

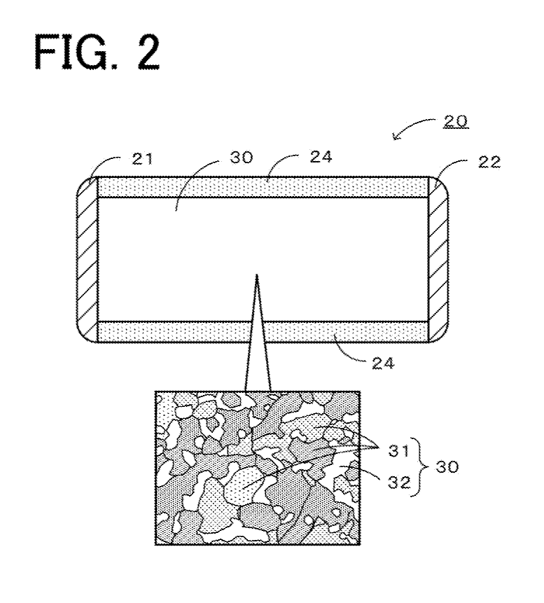

The shape of the electrode in the voltage nonlinear resistive element of the present invention, is not particularly limited but various shapes such as a rectangular shape, a stacked shape, a cylindrical shape, a wound type, and the like can be used. FIG. 2 shows an example of a voltage nonlinear resistive element 20 of the present invention. The voltage nonlinear resistive element 20 includes two electrodes 21 and 22 which are provided so as to face each other with a voltage nonlinear resistive material 30 provided therebetween, and further, in a portion in which the electrodes 21 and 22 are not formed, the surface of the voltage nonlinear resistive material 30 is covered with an insulating material 24. The voltage nonlinear resistive material 30 is composed of a copper alloy having a two-phase structure which contains a Cu phase 31 and a Cu—Zr compound phase 32 not containing a eutectic phase. The voltage nonlinear resistive material 30 may have a mosaic-shaped structure formed by the Cu phase 31 and the Cu—Zr compound phase 32. The Cu—Zr compound phase 32 may be a Cu₉Zr₂ phase.

Next, a method for producing the voltage nonlinear resistive material of the present invention is described. The method for producing the voltage nonlinear resistive material of the present invention may include (1) a powdering step of forming a Cu—Zr binary alloy powder, and (2) a sintering step of spark-plasma sintering the Cu—Zr binary alloy powder. Each of the steps is described below. In the present invention, the powdering step may be omitted by preparing the alloy powder in advance. In addition, the sintered body obtained by the sintering step may be subjected to a processing step of drawing or rolling.

(1) Powdering Step

In this step, the Cu—Zr binary alloy powder is formed from a Cu—Zr binary alloy. This step is not particularly limited but, for example, the alloy powder is preferably formed from the Cu—Zr binary alloy by a high-pressure gas atomization method. In this case, the average particle diameter of the alloy powder is preferably 30 μm or less. The average particle diameter corresponds to a D50 particle diameter measured using a laser diffraction-type particle size distribution measuring apparatus. The raw material is preferably a copper alloy containing Zr within a range of 0.2 at % or more and 15.0 at % or less, and either an alloy or a pure metal may be used. In this case, a Cu—Zr binary alloy having a hypo-eutectic composition may be used, or a cooper alloy containing Zr within a range of 5.0 at or more and 8.0 at % or less may used. Also, a copper alloy containing Zr within a range of 8.0 at % or more may be used. The raw material preferably does not contain an element other than Cu and Zr. In addition, the copper alloy used as the raw material need not contain the mosaic-shaped structure described above. The resultant alloy powder may contain dendrites terminated by rapid cooling during solidification. The dendrites may disappear in the subsequent sintering step.

(2) Sintering Step

In this step, a treatment of spark-plasma-sintering the resultant Cu—Zr binary alloy powder is performed. In this step, the treatment of spark-plasma sintering may be performed by applying a DC pulsed current so that the temperature is 0.9 Tm° C. or less (Tm(° C.) is the melting point of the alloy powder). In this step, the Cu—Zr binary alloy powder having an average particle diameter of 30 μm or less and a hypo-eutectic composition containing 5.00 at % or more and 8.00 at % or less of Zr may be used. In this step, the direct-current pulse may be within a range of 1.0 kA to 5 kA and more preferably within a range of 3 kA to 4 kA. The sintering temperature is a temperature of 0.9 Tm° C. or less, for example, 900° C. or less. The lower limit of the sintering temperature is a temperature which enables spark plasma sintering and is properly determined by the raw material composition and particle size and conditions of the direct-current pulse, but the lower limit may be 600° C. or more. The retention time at the maximum temperature is properly determined but, for example, can be determined to 30 minutes or less and more preferably 15 minutes or less. During spark plasma sintering, the alloy power is preferably pressed, for example, pressed at 10 MPa or more and more preferably 30 MPa or more. This can produce a compact copper alloy. The pressing method may include pressing the Cu—Zr binary alloy powder held in a graphite die using a graphite rod. The voltage nonlinear resistive material can be produced through this step.

According to the voltage nonlinear resistive element of the embodiment detailed above, a novel voltage nonlinear resistive element, including a Zr-containing copper alloy as a voltage nonlinear resistive material can be provided. That is, the copper alloy of the present invention can be used as the voltage nonlinear resistive material. Although the reason for achieving this effect is unclear, it is supposed as follows. For example, the voltage nonlinear resistive material of the present invention has a region composed of copper and a region containing at least zirconium in addition, the former plays the same function as a low-resistance crystal grain region of a ZnO varistor, and the latter plays the same function as a high-resistance crystal grain boundary region of a ZnO varistor, an electric barrier like a Schottky barrier being formed at the interface between both. It is thus supposed that when a voltage is increased in the voltage nonlinear resistive material of the present invention, a mechanism such as a tunneling effect acts due to overvoltage to cause a rapid increase in current, and the voltage-nonlinear resistance characteristics are supposed to be exhibited.

In addition, the present invention is not limited to the embodiment described above, and various embodiments can be made as long as they fall in the technical scope of the present invention.

### EXAMPLES

Specific examples of production of a voltage nonlinear resistive material used for a voltage nonlinear resistive element of the present invention are described below as examples. First, examples of a structure and phase constitution of a copper alloy used as a voltage nonlinear resistive material are described in Experiment Examples 1 to 3, and characteristics of a typical voltage nonlinear resistive material (Experiment Example 3) are described as examples.

### Experiment Examples 1 to 31

A Cu—Zr alloy powder prepared by a high-pressure Ar gas atomization method in the powdering step was used, and the powder was sieved to 106 μm or less. The alloy powders having Zr contents of 1 at %, 3 at %, and 5 at % were used in Experiment Examples 1 to 3, respectively. The particle size of each of the alloy powders was measured by using a laser diffraction-type particle size distribution measuring apparatus (SALD-3000J) manufactured by Shimadzu Corporation. The oxygen content in each of the powders was 0.100 mass %. SPS (spark plasma sintering) as the sintering step was performed by using a spark plasma sintering apparatus (Model SFS-3.2MK-IV) manufactured by SPS Syntex Inc. in a graphite die having a cavity of 50×50×10 mm, 225 g of the Cu—Zr alloy power was placed, and a De pulsed current of 3 kA to 4 kA was applied to form a copper alloy (SPS material) of each of Experiment Examples 1 to 3 at a heating rate of 0.4 K/s, a sintering temperature, of 1173 K (about 0.9 Tm: Tm is the melting point of the alloy), a retention time of 15 min, and a pressure of 30 MPa.

### Experiment Examples 4 to 6

As a reference, a copper alloy was formed by a copper-mold casting method. A Cu-4 at % Zr copper alloy, a Cu-4.5 at % Zr copper alloy, and a Cu-5.89 at Zr copper alloy were used in Experiment Examples 4 to 6, respectively. First, each of the Cu—Zr binary alloys each containing Zr at the content described above and the balance Cu was subjected to levitation melting in an Ar gas atmosphere. Next, a round rod ingot was cast by coating in a pure copper mold having a cavity engraved in a round rod shape with a diameter of 10 mm and then pouring the alloy melt at about 1200° C. The diameter of the resultant ingot measured by a micrometer was confirmed to be 10 mm. Next, the round rod ingot cooled to room temperature was drawn at room temperature by passing through 20 to 40 dies having holes with gradually decreasing diameters so that the diameter of a wire after drawing was 1 mm. In this case, the drawing rate was 20 m/min. The diameter of the copper alloy wire measured by a micrometer was confirmed to be 1 mm.

(Observation of Microstructure)

A microstructure was observed by using a scanning electron microscope (SEM), a scanning transmission electron microscope (STEM), and a nano-beam electron diffraction method (NBD).

(XRD Measurement)

Compound phases were identified by an X-ray diffraction method using a Co—Kα line.

(Evaluation of Electric Characteristics)

The electric properties of the resultant SPS materials of the experiment examples were examined by probe-type conductivity measurement and a four-terminal method for electric resistance measurement with a length of 500 mm. The conductivity was determined by measuring the volume resistance of the copper alloy according to JISH0505 and converting to conductivity (% IACS) by calculating a ratio to the resistance value (1.7241 μΩcm) of annealed pure copper. In converting to conductivity, an equation below was used. Conductivity γ (% IACS)=1.7241÷volume resistance ρ×100.

(Evaluation of Mechanical Characteristics)

Mechanical properties were measured using AG-1 (JIS B7721 Class 0.5) precision universal tester manufactured by Shimadzu Corporation according to JISZ2201. Then, tensile strength was determined as a value obtained by dividing the maximum load by the initial sectional area of the copper alloy wire.

(Consideration of Copper Alloy Powder)

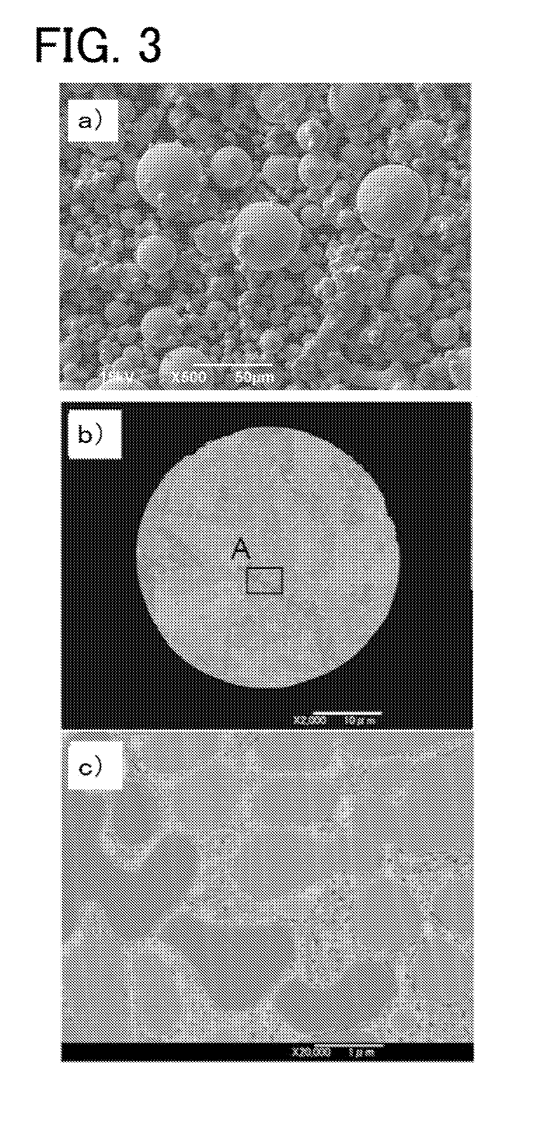

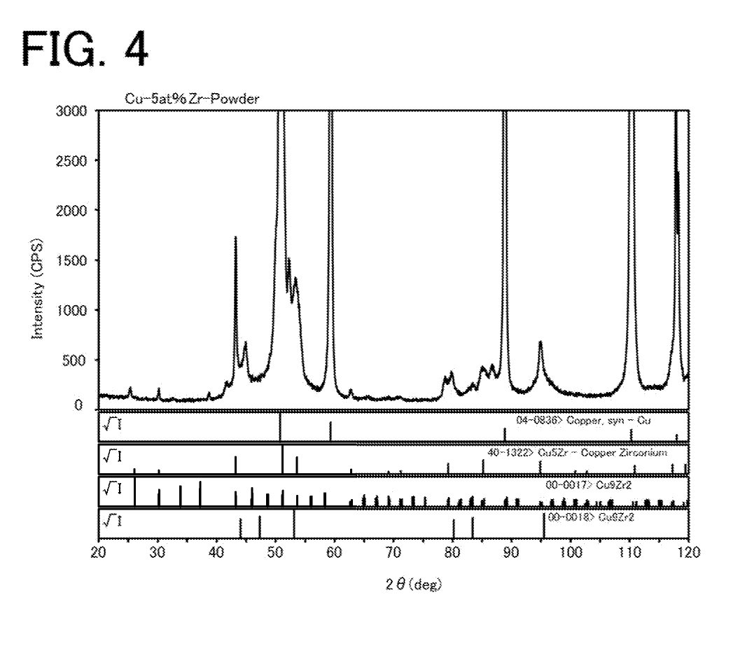

FIG. 3 shows sectional SEM-BEI images of the Cu-5 at % Zr alloy powder produced by a high-pressure Ar gas atomization method (then sieved to 106 μm or less). The particle diameter was 36 μm. In addition, dendrites considered to be terminated by rapid cooling during solidification were observed. As a result of measurement of secondary DAS (Dendrite Arm Spacing) at arbitrary four positions, the average value was 0.81 μm. This value was one digit smaller than 2.7 μm of the Cu-4 at % Zr alloy produced by the copper-mold casting method and thus exhibited a rapid cooling effect. Some aggregation was observed in the powder, but flakes produced by collision with a spray chamber wall were decreased by removal. The Cu-1 at %, Cu-3 at %, and Cu-5 at % Zr alloy powers had average particle diameters of 26 μm, 23 μm, and 19 μm, and had standard deviations of 0.25 μm, 0.28 μm, and 0.32 μm, respectively. The particle diameter of any one of the compositions had a substantially lognormal distribution within the range of a measurement limit of 1 μm to 106 μm. Next, FIG. 4 shows the results of measurement of the Cu-5 at % Zr alloy powder by an X-ray diffraction method. X-ray diffraction peaks of a α-Cu phase as a parent phase and a Cu₅Zr compound phase in a eutectic phase were observed. Also, besides these, a small amount of diffraction peak considered to be Cu₉Zr₂ was observed as a Cu—Zr compound phase.

(Consideration of SPS Material)

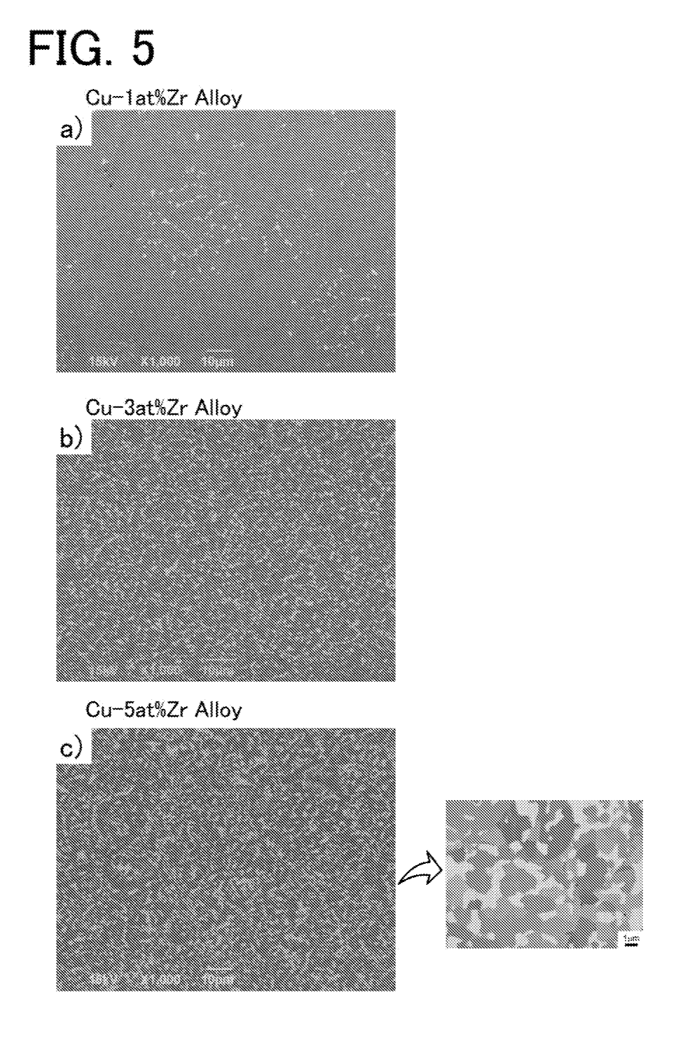

FIG. 5 shows SEM-BEI images of a rectangular plate formed by SPS of a Cu—Zr alloy powder, in which FIG. 5(a) shows a Cu-1 at % Zr alloy, FIG. 5 (b) shows a Cu-3 at % Zr alloy, and FIG. 5(c) shows a Cu-5 at Zr alloy. The structure of each of the SPS material was a uniform compact two-phase structure. This structure was different from the cast structures of the Cu—Zr alloys formed by the copper mold casting method in Experiment Examples 4 to 6. Also, this is the biggest characteristic of the structure formed by SPS solid-phase bonding of powder particles produced by rapid cooling. In addition, as a result of SEM-EDX analysis of each of the phases of the SPS material of Experiment Example 3, Cu and a trace of Zr were observed in the gray parent phase, and thus an et-Cu phase was confirmed. On the other hand, the amount of Zr analyzed in the white second phase was 16.9 at %. Also, the SPS material of Experiment Example 3 stoichiometrically well agreed with a Cu₅Zr compound phase (Zr ratio of 16.7 at %), and thus the second phase was found to contain a Cu₅Zr compound. That is, the Cu₅Zr compound phase observed in the powder material was maintained even after SPS. In addition, the specific gravities of the SPS materials of the Cu-1 at %, Cu-3 at %, and Cu 5 at % Zr alloys shown in FIG. 5 measured by an Archimedes method were 8.92, 8.85, and 8.79, respectively, and thus the SPS materials were found to be sufficiently compacted.

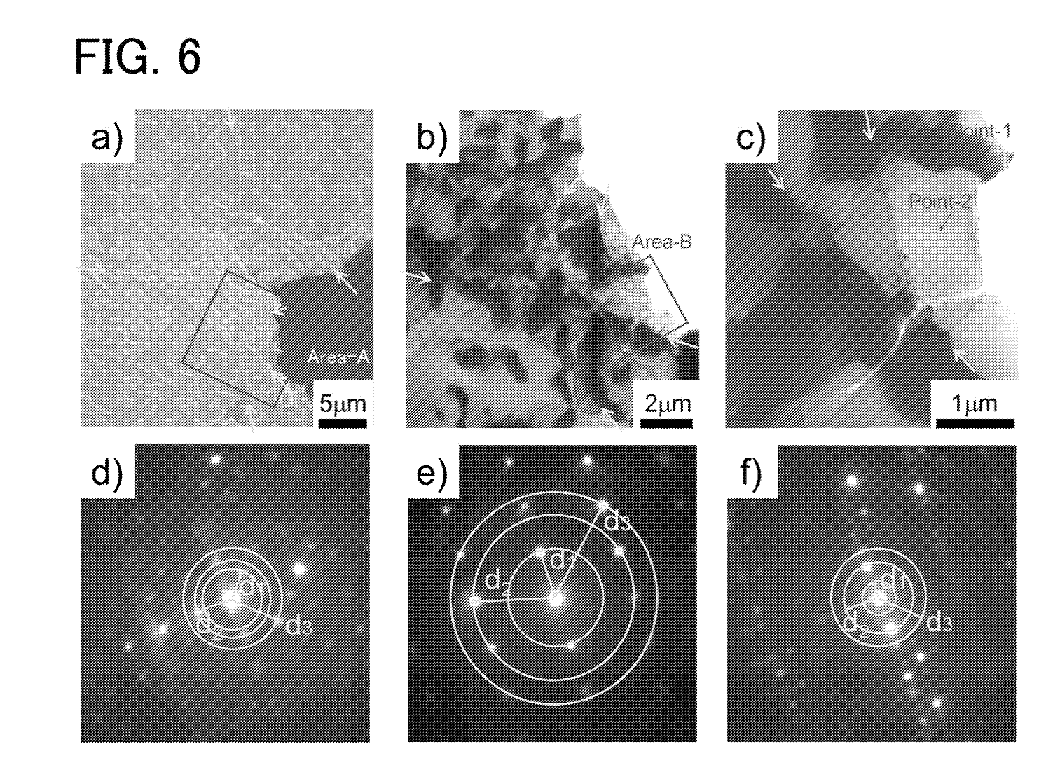

FIG. 6 shows FE-SEM images of the Cu-5 at % Zr ally (the SPS material of Experiment Example 3), in which FIG. 6(a) is a FE-SEM image of a thin film sample formed by electrolytically polishing the SPS material of Experiment Example 3 using a twin-jet method, FIG. 6(b) is a BE image obtained by STEM observation of Area-A in FIG. 6(a), and FIG. 6(c) is a BE image obtained by STEM observation of Area-B in FIG. 6 (b). Also FIG. 6 (d) shows a NIB pattern of Point-1 in FIG. 6(c), FIG. 6(e) shows a NDB pattern of Point-2 in FIG. 6(c), and FIG. 6(f) shows a NDB pattern of Point-3 in FIG. 6(c). Electrolytic polishing by the twin-jet method was performed by using as an electrolyte a mixture of 30% by volume of nitric acid and 70% by volume, of methanol. The electrolytic polishing enabled remarkable observation of a two-phase structure because of a high etching rate of a Cu phase. In the diagrams, marks of powder particle interfaces remain on curves held between arrows, and fine particles considered as oxide are scattered along the interfaces. In the other viewing fields, twin crystals extending from the particle interfaces into the Cu phase were observed, and also the presence of voids of with size of 50 to 100 mm was very slightly observed. In FIG. 6(b), a black phase containing the Cu₅Zr compound was dispersed in a mosaic pattern in the α-Cu phase. In addition, dislocation was only slightly observed in the to phase, and a structure considered to be coarsened by sufficient recovery or recrystallization was exhibited. In FIG. 6(c), oxide particles with a size of about 30 to 80 nm were scattered along the powder particle interfaces.

Table 1 shows the results of EDX point analysis at the arrow points of Point-1 to 3 shown in FIG. 6(c). Point 1 was estimated to be the Cu₅Zr compound phase. Also, Point-2 was estimated to be the Cu phase. Although, in this case, detection was impossible by the results of measurement of Point-2 for the reason of analytical precision, it was estimated that Zr is contained in, an oversaturated state at about 0.3 at %. On the other hand, the analysis results of a rod-shaped oxide of Point-1 indicated that the oxide is a compound oxide containing Cu and Zr. As shown FIGS. 6(d) to (f), different diffraction spots shown by d1, d2, and d3 were obtained, and Table 2 shows the lattice plane distances determined from these spots. Table 2 also shows, as comparison, lattice parameters calculated on specified crystal planes of Cu₅Zr, Cu₉Zr₂, and Cu₈Zr₃ compounds and Cu, C₈O₇, Cu₄O₃, and Cu₂O₂ oxides which have been observed in Cu-0.5 to 5 at % Zr alloy wires with a hypoeutectic structure. The NBD pattern of Point 1 substantially coincides with the lattice parameters of the Cu₅Zr compound. Point-2 substantially coincides with the lattice parameters of Cu. On the other hand, the NBD pattern of Point-3 does not coincide with the lattice parameters of any one of the Cu oxides. Therefore, it was considered that at Point-3, fine particles on the powder particle interfaces may include a compound oxide containing Zr atoms. The results of FIGS. 6(a) to (c) and Table 2 revealed that Point-1 is a Cu₅Zr compound single phase, Point-2 is an a-Cu phase, and Point-3 is an oxide particle containing Cu and Zr.

TABLE 1

| | O | Cu | Zr |
|---|---|---|---|
| Point | (at %) | (at %) | (at %) |
| 1 | — | 83.5 | 16.5 |
| 2 | — | 100.0 | — |
| 3 | 34.3 | 55.3 | 10.4 |

TABLE 2

| Point-1 | | Point-2 | | Point-3 | |
|---|---|---|---|---|---|
| Symbol | Distance/nm | Symbol | Distance/nm | Symbol | Distance/nm |
| d₁ | 0.3431 | d₁ | 0.1809 | d₁ | 0.5686 |
| d₂ | 0.2427 | d₂ | 0.1087 | d₂ | 0.2653 |
| d₃ | 0.1716 | d₃ | 0.0829 | d₃ | 0.1895 |

| | System of | Lattice | Lattice |
|---|---|---|---|
| Phase | symmetry | plane | parameter/nm |
| Cu₅Zr | cubic | (200) | 0.3435 |
| | | (220) | 0.2429 |
| | | (400) | 0.1717 |
| Cu₉Zr₂ | tetragonal | (200) | 0.3428 |
| | | (220) | 0.2424 |
| | | (400) | 0.1714 |
| Cu₈Zr₃ | orthorhombic | (121) | 0.3403 |
| | | (311) | 0.2422 |
| | | (215) | 0.1740 |
| Cu | cubic | (200) | 0.1808 |
| | | (311) | 0.1090 |
| | | (331) | 0.0829 |
| Cu₈O₇ | tetragonal | (100) | 0.5817 |
| | | (210) | 0.2601 |
| | | (222) | 0.1899 |
| Cu₄O₃ | tetragonal | (101) | 0.5010 |
| | | (211) | 0.2517 |
| | | (301) | 0.1904 |
| Cu₂O | cubic | (100) | 0.4217 |
| | | (111) | 0.2435 |
| | | (210) | 0.1886 |

Consequently, the Cu₅Zr compound observed in the SPS materials had a single phase and was different from a eutectic phase (Cu+Cu₉Zr₂) of a sample formed by the copper mold scattering method. That is, a dendrite structure including an α-Cu phase and a eutectic phase (Cu+Cu₅Zr) observed with the powder material was changed to a two-phase structure including an α-Cu phase and a Cu₅Zr compound single phase by SPS. Although a mechanism working in this change is unclear, it is considered that for example, rapid dispersion of Cu atoms is caused by great electric energy supplied from a large current during heating to 1173 K and holding at the temperature for 15 minutes in the SPS method, and thus recovery of the Cu phase or dynamic or static recrystallization and secondary growth of the Cu phase is accelerated, thereby possibly causing tow-phase separation. In addition, with respect to the oxide films on the surfaces of the powder particles, it was considered that the oxide is reduced or destructed and fragmented by SPS in the graphite die but is not completely reduced even with an alloy containing active Zr, leaving oxide particles in the SPS material.

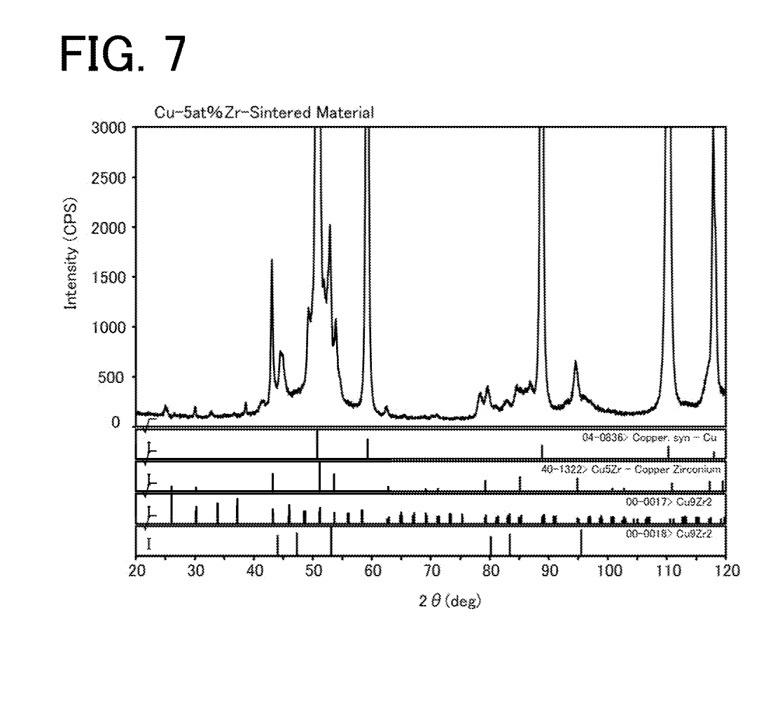

FIG. 7 shows the results of X-ray diffraction measurement of the Cu-5 at % Zr alloy (the SPS material of Experiment Example 3). Like the powder material, the SPS material contains a Cu phase and a Cu₅Zr compound phase, and the position of each of diffraction peaks of the SPS material slightly shifts to the low-angle side from the powder material. This indicates that the lattice parameters the SPS material are larger than the powder material. This is considered to be due to relaxation of lattice strain by heating and holding during SPS, the lattice strain being introduced in the powder material by rapid cooling in the high pressure gas atomization method.

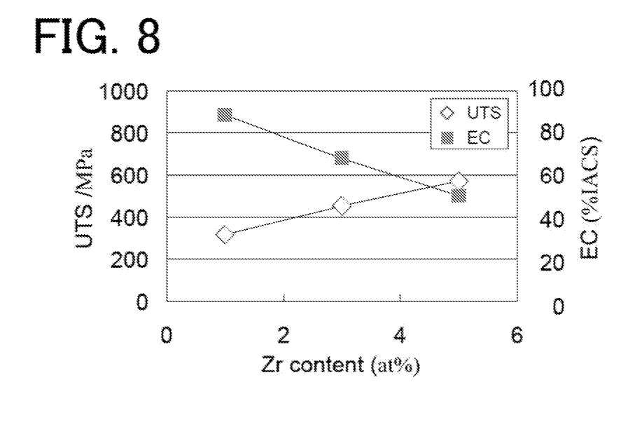

FIG. 8 shows the results of measurement of tensile strength (UTS) and conductivity (EC) of samples taken from cross sections parallel to the pressure direction of the SPS materials of the Cu-1, 3-, and 5-at % Zr alloys. With respect to the Zr amount, strength increases with increases in the Zr content, and conductivity decreases with increases in the Zr content. The value of conductivity of each of the SPS materials is higher than for example, the conductivity of 28% (IACS) of the Cu-4% Zr alloy as-cast material formed by the copper mold casting method. This is considered to be due to compact network-like bonding of Cu phases in the powder particles by SPS.

### Example 1

The copper alloy of Experiment Example 3 was formed and used as a voltage nonlinear resistive material of Example 1.

[AFM Current Measurement]

AFM-current simultaneous measurement was performed by using E-Sweep and Nano Navi station manufactured by SII. A shape was measured by scanning while a probe was in contact with a sample in an AFM (Atomic Force Microscope) mode. Also, a current distribution was measured by scattering in a CITS (Current Imaging Tunneling Spectroscopy) mode. A DC bias was 1.0 V, and a measurement area was within a range of 10 μm×10 μm. The sample was prepared by section processing with a cross-section polisher (CP) and FIB (Focused Ion Beam) marking.

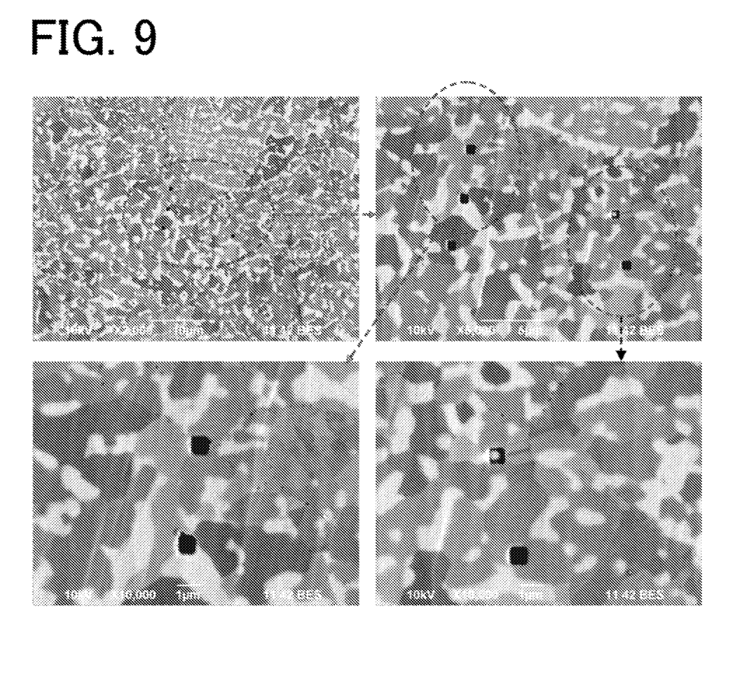

FIG. 9 shows cross-sectional SEM images of the voltage nonlinear resistive material of Example 1. A portion appearing white is a Cu—Zr compound phase, and a portion appearing black is a Cu phase. It was confirmed by the SEM composition images that the voltage nonlinear resistive material of Example 1 constitutes a structure in which the Cu phase and the Cu—Zr compound phase are dispersed in a mosaic pattern. In addition, square marks scattered in the SEM composition images are marks caused by FIB (Focused Ion Beam) processing.

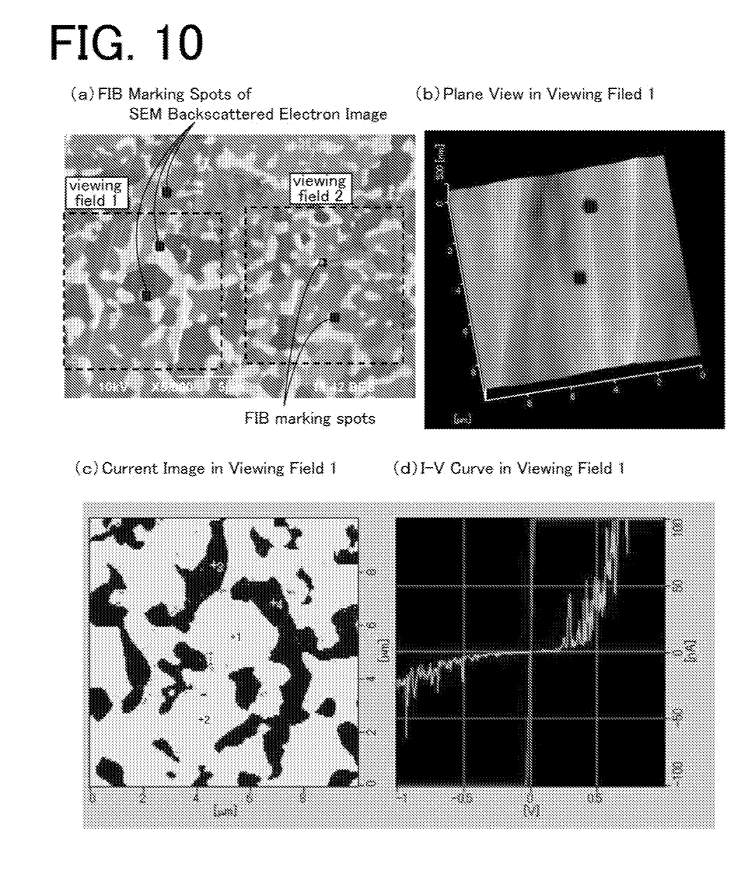

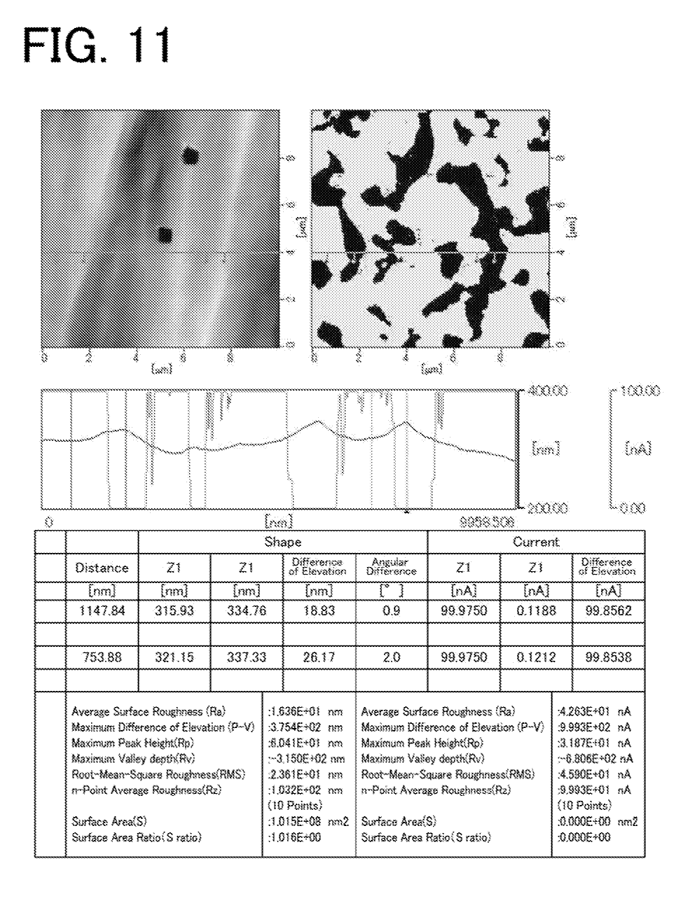

FIG. 10 shows a sectional SEM composition image and AFM-current measurement results of the voltage nonlinear resistive material of Example 1, in which FIG. 10(a) is a SEM backscattered electron image, FIG. 10(b) is a plane view in a viewing field 1 of FIG. 10(a), FIG. 10(c) is a current image in the viewing field 1, and FIG. 10(d) is a I-V curve in the viewing field 1. FIG. 11 is a diagram showing the analysis results of AFM-current measurement, that is, a diagram showing a plane view in the viewing field 1, a current image, and scanning results on a measurement line. As seen from FIGS. 10 and 11, a particularly light portion in the plane view does not coincide with a particularly light portion in the current image, and thus it was found that irregularity on the surface of the sample does not influence the current value. On the other hand, in the current image, the Cu-phase portion of the SEM composition image appears light, and the Cu—Zr compound phase portion appears dark, and it was thus found that much current flows through the Cu phase, while little current flows through the composite phase. The same results were obtained on the arbitrary measurement line as shown in FIG. 11. FIGS. 10(c) and (d) are the current image and the I-V curve at each point of the current image, respectively, in the viewing field 1 of the voltage nonlinear resistive material of Example 1. In FIGS. 10 and 11, it was found that points 1 and 2 in the Cu phase appearing light in the current image show the conductive material characteristics that current linearly increases in proportion to increases in voltage. On the other hand, it was found that the Cu—Zr compound phase appearing dark in the current image, that is, points 3 and 4, show the voltage nonlinear resistance characteristics that conductivity is exhibited when a voltage exceeds a specified value. A current rise from about 0.4 V was observed at the points 3 and 4. In measurement shown in FIGS. 10 and 11, the current image was measured by applying a DC bias of 0.3 V in a viewing field of 10 μm×10 μm, and the I-V curve was measured by changing the bias voltage from −0.1 V to 1.0 V.

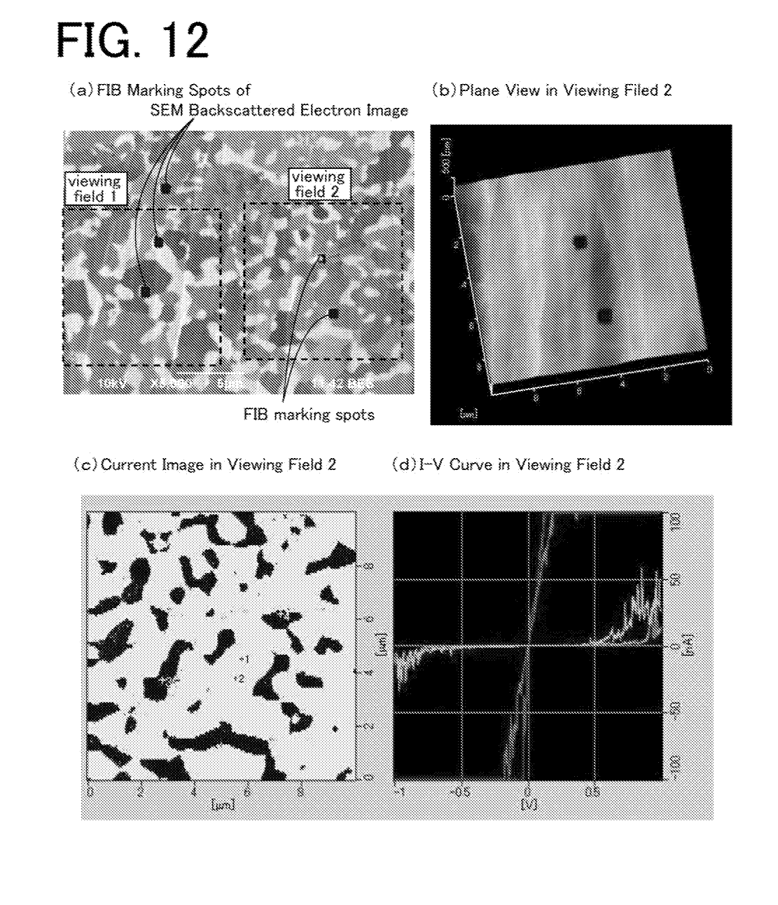

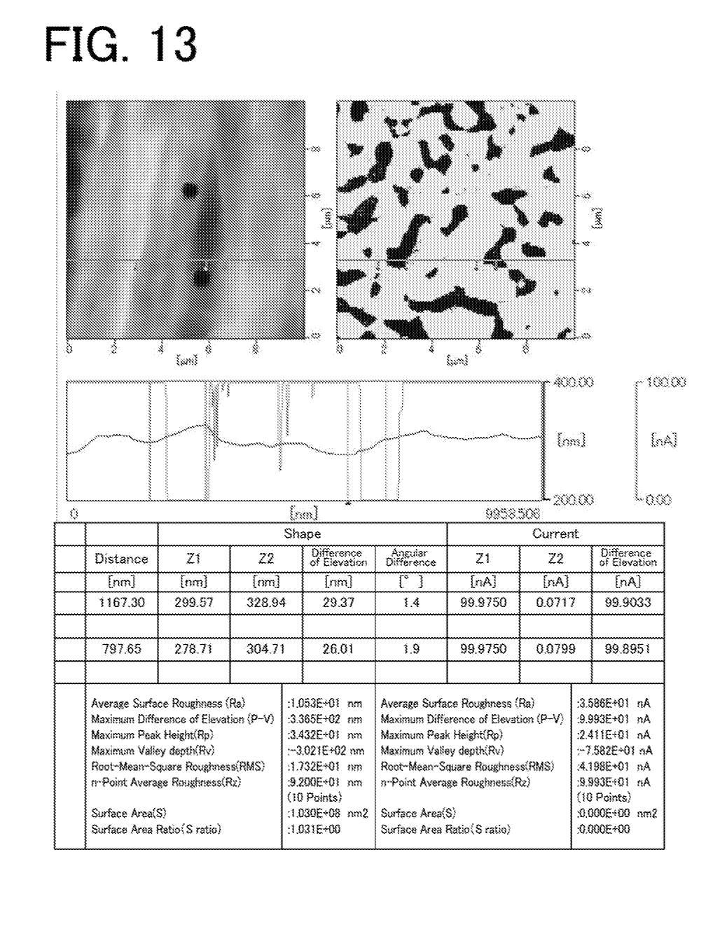

FIG. 12 shows a SEM composition image and the results of AFM-current measurement of the voltage nonlinear resistive material of Example 1, in which FIG. 12(a) is a SEM backscattered electron image, FIG. 12(b) is a plane view in a viewing field 2 of FIG. 12(a), FIG. 12(c) is a current image in the viewing field 2, and FIG. 12(d) is a I-V curve in the viewing field 2. FIG. 13 shows the analysis results of AFM-current measurement, that is, a diagram showing a plane view, a current image, and scanning results on a measurement line in the viewing field 2. FIGS. 12 and 13 show the same results of the current image and I-V curves as in FIGS. 10 and 11. In FIG. 12, a current rise from about 0.6 V was observed at the points 3 and 4.

(Consideration)

The above revealed that a copper alloy containing a Cu—Zr compound phase exhibits voltage nonlinear resistance characteristics and can be used for a voltage nonlinear resistive element. Also, it was found that a current flows at a relatively low voltage near 1 V. Therefore, it was found that a voltage nonlinear resistive element operating within a low voltage region (for example, 0.2 V to 3 V) can be more easily manufactured.

The present application claims priority from Japanese Patent Application No. 2012-260608 filed on Nov. 29, 2012, the entire contents of which are incorporated herein by reference.

### INDUSTRIAL APPLICABILITY

The present invention can be utilized in a technical field relating to manufacture of a resistive element.

What is claimed is:

1. A voltage nonlinear resistive element comprising:
a voltage nonlinear resistive material composed of a copper alloy having a two-phase structure which contains Cu and a Cu—Zr compound not containing a eutectic phase; and
an electrode.

2. The voltage nonlinear resistive element, according to claim 1, wherein the Cu—Zr compound of the voltage nonlinear resistive material is at least one of Cu₅Zr, Cu₉Zr₂, and Cu₈Zr₃.

3. The voltage nonlinear resistive element, according to claim 1, wherein the voltage nonlinear resistive material is formed by spark plasma sintering of a Cu—Zr binary alloy powder.

4. The voltage nonlinear resistive element according, to claim 3, wherein the voltage nonlinear resistive material is formed by the Cu—Zr binary alloy powder formed by a high-pressure gas atomization method using a Cu—Zr binary alloy.

5. The voltage nonlinear resistive element according to claim 1, wherein the voltage nonlinear resistive material has a mosaic-shaped structure in which crystals with a size of 10 μm or less are dispersed in a cross-sectional view.

6. The voltage nonlinear resistive element according to claim 1, wherein the voltage nonlinear resistive material contains 0.2 at % or more and 18.0 at % or less of Zr.
